(19) United States
(12) Patent Application Publication
(10) Pub. No.: US 2025/0075724 A1
(43) Pub. Date: Mar. 6, 2025

(54) Anchor Sleeve, Arrangement and Method of Securing

(71) Applicant: Adolf Würth GmbH & Co. KG, Künzelsau (DE)

(72) Inventor: Christian Spirk, Künzelsau (DE)

(21) Appl. No.: 18/820,745

(22) Filed: Aug. 30, 2024

(30) Foreign Application Priority Data
Sep. 1, 2023 (DE) 102023123591.5

(51) Int. Cl. F16B 13/14

(52) U.S. Cl. CPC F16B 13/146

(57) ABSTRACT

Anchor Sleeve, Arrangement and Method of Securing

The invention relates to an anchor sleeve for an injection system for securing of an anchor element in an opening in an article, especially in a borehole in masonry, wherein the anchor sleeve consists at least in sections of flexible permeable open-cell foam.

### FIELD OF THE INVENTION

The invention relates to an anchor sleeve for an injection system for securing an anchor element in an opening in an article, especially in a borehole in masonry. The invention also relates to an arrangement having an anchor element and an anchor sleeve according to the invention. The invention also relates to a method of securing an anchor element in an opening of an article by means of an anchor sleeve according to the invention.

### BACKGROUND

Anchor sleeves for injection systems for securing an anchor element in a hole are known; see, for example, the Würth perforated sleeve SH16×85, Art. No. 090344164. The anchor sleeve, also referred to as perforated sleeve, has been provided with a mesh at least in sections around its circumference. The anchor sleeve is inserted into a hole and then filled with an injection mortar. Thereafter, an anchor element, typically an anchor rod, is inserted into the anchor sleeve, and this displaces excess injection mortar onto the outer surface of the perforated sleeve. The injection mortar thus passes through the mesh of the anchor sleeve and gets onto the outside of the anchor sleeve. Introduction of load into the masonry is ensured essentially by the form fit, called plugging, between the anchor rod, the anchor sleeve and the cured injection mortar, and the cavity of the anchoring ground. In general, the highest load-bearing capacity is expected in the case of compact plugging. This means that the injection mortar pushed through the anchor sleeve coalesces again on the outside of the anchor sleeve. In order to achieve this, the consistency of the injection mortar must be matched to the size of the openings and element widths between the openings of the anchor sleeve in order not to result in formation of so-called spaghetti by the mortar. This is because it is possible in such a case for the individual filaments of mortar or spaghetti to be sheared off easily under stress. This is referred to as the zip effect, which leads to a lower load-bearing capacity. A standard perforated sleeve made of plastic with a total length of L=85 mm and an external diameter of d=16 mm is typically used in combination with anchor rods of size M8 and M10. Such anchor rods are essentially standard threaded rods. An anchor rod of size M12 can theoretically be used in the same perforated sleeve, but an inadequate bond is observed here in some cases between anchor rod and perforated sleeve. In particular, this is true for the upper region at the start of the hole. In general, this observation can be attributed to the very small ring gap or to the small amount of mortar between anchor rod and perforated sleeve that remains after the anchor rod has been inserted. The remaining mortar is deposited in the thread flanks of the anchor rod and, because of the cohesion of the mortar and the small openings in the perforated sleeve, lack of mortar can no longer seep from the outside back into the perforated sleeve. By virtue of the different diameters or volumes of the anchor rods, different amounts of mortar are displaced to the outside on insertion, i.e. through the perforated sleeve in radial direction. For the same amount of mortar injected, this gives rise to form fits of different size or shape.

### SUMMARY

The invention is intended to improve an anchor sleeve for an injection system, an arrangement having an anchor element and an anchor sleeve, and a method of securing an anchor element in an opening in an article by means of an anchor sleeve.

According to the invention, for this purpose, an anchor sleeve for an injection system having the features of claim 1, an arrangement having the features of claim 16, an arrangement having the features of claim 19, and a method having the features of claim 22 are provided. Advantageous developments of the invention will be apparent from the dependent claims.

An anchor sleeve for an injection system for securing an anchor element in an opening in an object, especially in a borehole in masonry, is configured in accordance with the invention such that the anchor sleeve consists at least in sections of flexible permeable foam with an open pore structure.

Surprisingly, the use of flexible permeable foam with an open pore structure in an anchor sleeve offers considerable benefits in the securing of an anchor element by means of an anchor sleeve and injection mortar. The use of flexible foam permits the introduction of oversize anchor sleeves into an opening or a borehole in hollow bricks. The flexible, elastic or resilient material, i.e. the foam, can be pushed through an opening having relatively small diameter and adapts to the contour of the anchoring ground by expansion owing to what is called memory capacity or owing to resilience. As a result, the anchor sleeve itself or the foam itself may also become part of the form fit of the anchoring. For example, a borehole is made in a hollow brick. An anchor sleeve having a foam element of greater diameter than the borehole, by virtue of the fact that the foam is compressible, can be pushed through the opening, and the foam expands again beyond the opening. This cannot be achieved by conventional perforated sleeves, such that the cylindrical shell of the injection-moulded polymer mouldings forms a shear surface in the case of conventional sleeves. In the case of conventional perforated sleeves, form-fitting has to be assured via the amount of escaping mortar. In the case of the anchor sleeve according to the invention, the formation of a distinct form fit is thus made significantly easier, such that system reliability and load-bearing capacity are increased.

The structure of the foam is comparable with the random layers of a nonwoven. This gives rise to a permeability that does not follow a linear channel opening of symmetrically arranged openings or holes and cell walls. The formation of mortar filaments and hence the so-called spaghetti effect is thus reduced to a minimum. Instead, air inclusion-free or homogeneous and compact plugging by the injection mortar is promoted. Because of the suppressed spaghetti formation and the high surface area of the foam, the adhesion capacity of the injection mortar or of the anchor sleeve is increased, and it is possible to employ injection mortar systems having different viscosities or compositions, especially with a different filler level. Any spaghetti formation observed on the foam surface only slightly affects the load-bearing capacity of the mortar plug since it is mainly the filled or the mortar-impregnated foam that acts as the form fit.

The high surface area of the foam increases the adherence and adhesion, respectively, of the injection mortar on and in the foam and reduces dripping of the mortar off the foam sleeve, for example in cavities of a hollow brick.

Because of the flexible foam, an internal diameter of the anchor sleeve can accommodate different anchor rod diameters and hold them centrally in the hole. This is because the foam does of course also give on the inside of the anchor sleeve and yields to an anchor rod. In the case of an anchor sleeve according to the invention with a nominal diameter of d=16 mm, it is possible thereby to extend the range of application of usable anchor rods to include the anchor rod diameter M12, and so it is possible as a result to use M8, M10 and M12 anchor rods. This is because no annular gap exists between the anchor rod and the foam of the anchor sleeve. The internal diameter of the anchor sleeve is always less than or equal to the anchor rod diameter and, because of the flexible or compressible foam, the anchor rod surface is always in contact with the mortar-impregnated foam. This is the case even when the anchor rod, after being introduced into the anchor sleeve, is moved in the as yet uncured foam that is impregnated with injection mortar. This considerably increases reliability of use.

The foam used may, for example, be an open-cell filter foam based on polypropylene (PP), polyamide (PA), polyethylene (PET) or the like. Such a filter foam finds use, for example, as water filter in aquarium keeping and has irregularly distributed different-sized pores.

In a development of the invention, the anchor sleeve has a tube-like element made of the foam.

In this way, it is possible to ensure that a holding section of the anchor element is completely surrounded by the foam, such that a very good form fit can be achieved between anchor element and foam. The tube-like element may have two open ends.

In a development of the invention, the tube-like element made of foam forms a blind hole.

In this way, the anchor sleeve can be filled with injection mortar in a very simple manner since it can be ensured by means of a blind hole that the end of the tube-like element present in the hole also does not offer any lower outflow resistance than the circumferential wall of the tube-like element. This also facilitates securing of the tube-like element made of the foam to a carrier.

In a development of the invention, a number of pores in the foam is between 15 PPI (pores per inch) and 25 PPI, especially 20 PPI.

Such a number of pores in the open-cell foam has been found to be extremely advantageous for use in an anchor sleeve for an injection system.

In a development of the invention, a carrier with an end piece and an entry flange is provided, where the foam is secured to the carrier.

A carrier with an end piece and an entry flange permits reliable securing of the flexible foam and ensures that the anchor sleeve can be introduced into an opening without damage.

In a development of the invention, the end piece and the entry flange are joined by means of at least one connecting strip.

Such a connecting strip stabilizes the anchor sleeve; in particular, a tube-like element made of the foam is stabilized.

In a development of the invention, the at least one connecting strip is provided with anchoring elements, especially sawteeth and/or hooks, for engaging with the foam.

In this way, it is possible to ensure that, when the anchor sleeve is inserted into an opening, the foam, rather than shifting excessively relative to the carrier, can be inserted to the desired depth in the opening. Anchoring elements on the connecting strip ensure here reliable functioning of the anchor sleeve without requiring additional bonding or any other connection between foam and carrier.

In a development of the invention, the sawteeth and/or hooks extend away from the connecting strip in circumferential direction of the tube-like element made of foam.

It has been found that such an arrangement of the sawteeth and/or hooks ensures a reliable hold of the foam on the carrier on insertion of the anchor sleeve into an opening.

In a development of the invention, the sawteeth are aligned partly in a direction toward the end piece and partly in a direction away from the end piece.

In this way, it can be ensured that the anchor sleeve, if necessary, can also be pulled back out of the opening to some degree without any significant change in a position of the foam relative to the carrier, i.e. without the foam collapsing.

In a development of the invention, the tube-like element made of foam has been provided with at least one groove that runs in the longitudinal direction, and the connecting strip is disposed in the groove.

In this way, it is possible to assure reliable securing of the foam to the carrier. For example, the tube-like element made of foam has two opposite grooves and in each case one connecting strip of the carrier is disposed in each groove.

In a development of the invention, the groove extends from an outer face of the tube-like element inward.

In this way, reliable securing and simple assembly of the carrier and the tube-like element made of foam are possible.

In a development of the invention, a carrier has been provided with an end piece and an entry flange, where the foam is connected to the end piece and/or to the entry flange, especially clamped to the end piece and to the entry flange.

The flexible foam is reliably secured to the end piece and/or the entry flange via the connection, such that the anchor sleeve according to the invention can be inserted into an opening without any risk of shifting of the foam relative to the carrier.

In a development of the invention, the end piece has been provided with a passage opening and the foam is clamped to the end piece by means of a clamping rivet inserted into the passage opening.

In this way, it is possible to achieve a reliable connection between foam and carrier. The clamping rivet, when the foam is in the form of a tube-like element with a blind hole, can be pushed through the foam in order thus to achieve particularly reliable securing. The foam, for example in the case of a tube-like element with two open ends, may also be pushed radially outward by the clamping rivet and hence be clamped and in particular also sealed at the end piece.

In a development of the invention, the at least one connecting strip, at its opposite end from the end piece, has been provided with a holding shell, and the entry flange is formed by means of an entry bushing, where the foam is clamped between the holding shell and the entry bushing.

In this way too, the foam can be very reliably secured to the carrier since the foam can be clamped against the entry bushing over the entire area of the holding shell. For example, the carrier has two connecting strips and hence two holding shells, both of which are pushed against the entry bushing and here clamp the foam between a respective holding shell and the entry bushing.

In a development of the invention, the end piece, on its side facing the entry flange, has been provided with a frustoconical guide section that tapers in the direction away from the entry flange.

In this way, the anchor sleeve, on insertion, can be guided into an opening, such that insertion is facilitated. The side facing the entry flange may serve as a guide for the end piece of an injection mortar injector and also as a guide for an anchor element, in order to centrally align the anchor element relative to the anchor sleeve.

In an arrangement having an anchor element and an anchor sleeve according to the invention, the anchor sleeve has a tube-like element made of the foam and the anchor element has an anchoring section designed for insertion into the tube-like element, where an internal diameter of the tube-like element, at least in sections, is less than or equal to the external diameter of the anchor element in the anchoring section.

In this way, it is ensured that an outer circumference of the anchor element in the anchoring section adjoins the inside of the tube-like element made of foam. This can achieve a particularly reliable connection between the anchor sleeve and the anchor element in the anchoring section. The smaller or equal internal diameter of the tube-like element compared to the external diameter of the anchor element also ensures reliable guiding and centring of the anchor element on introduction into the tube-like element.

In a development of the invention, an external diameter of the tube-like element, at least in sections, is greater than the internal diameter of an opening intended for introduction of the anchor sleeve.

In this way, the tube-like element made of foam, after being inserted into an opening, for example into a hollow brick, can expand in radial direction. After the foam has been filled with injection mortar, this ensures uniform plugging and hence a reliable form fit of the anchor sleeve.

In a development of the invention, the anchor element has been inserted into the anchor sleeve to such an extent that one end of the anchor element adjoins an inner face of an end piece of the anchor sleeve.

In a further arrangement with an anchor sleeve according to the invention, the anchor sleeve has a tube-like element made of foam, and an anchor element, an opening in an article, especially a borehole in a building wall, and injection mortar are provided, wherein the anchor sleeve has been inserted at least in sections into the opening, wherein the injection mortar has at least partly filled the pores in the foam, wherein the anchor element has been inserted in sections into the anchor sleeve, wherein the foam has been displaced radially outward at least in sections with respect to a starting position prior to the introduction of injection mortar into the anchor sleeve and prior to insertion of the anchor element into the anchor sleeve, and wherein the anchor element at least in sections adjoins an inner face of the tube-like element made of foam, the pores of which have been at least partly filled with the injection mortar.

In such an arrangement, a form fit between the anchor sleeve and the article is improved by the foam that has been displaced radially outward at least in sections. A connection between the anchor element and the anchor sleeve is improved in that the anchor element at least in sections adjoins an inner face of the tube-like element made of the foam.

In a development of the invention, a section of the tube-like element made of foam, the pores of which have been at least partly filled with the injection mortar, immediately beyond an entry element of the hole, forms a toroidal structure, the external diameter of which is greater than the internal diameter of the opening.

Such a so-called doughnut formation permits a reliable form fit between anchor sleeve and article, and is to be observed when the anchor sleeve is used in hollow bricks or generally with cavities beyond an entry wall. The formation of a toroidal structure can be promoted by means of injection of the injection mortar beginning at the open end or just beyond the open end of the anchor sleeve.

In a development of the invention, a section of the tube-like element made of foam, the pores of which have been at least partly filled with the injection mortar, between the opening and a further opening in an inner element of the article, forms a cylinder-like or toroidal structure, the external diameter of which is greater than the internal diameter of the opening.

Such cylinder-like plugging ensures a reliable form fit between anchor sleeve and the article. Such cylindrical plugging can be promoted by introduction of the injection mortar into the anchor sleeve beginning from the base of the anchor sleeve.

A method of securing an anchor element in an opening of an article by means of an anchor sleeve according to the invention comprises insertion of at least sections of the anchor sleeve into the opening, introduction of injection mortar into the anchor sleeve and insertion of sections of the anchor element into the anchor sleeve.

A development of the invention comprises placing of the anchor sleeve onto an injection mortar injector, especially until a free end of the injection mortar injector hits an end piece of the anchor sleeve, and inserting the anchor sleeve into the opening together with the injection mortar injector.

In this way, the anchor sleeve can be inserted into the opening reliably and without deformation since it is stabilized by the injection mortar injector on insertion. Immediately after the insertion, the injection mortar can then be introduced into the anchor sleeve beginning from the base of the anchor sleeve. This is because the open end of the injection mortar injector then rests against the base of the anchor sleeve, so as to assure procedurally reliable introduction of the injection mortar, especially with regard to complete filling of the anchor sleeve with injection mortar.

The injection mortar can also be introduced into the anchor sleeve beginning at the open end or just beyond the open end of the anchor sleeve, especially beginning in a first third of the length of the anchor sleeve.

The foam prevents the injection mortar from flowing rapidly out of the anchor sleeve. Even in the case of introduction of the injection mortar beginning at the open end of the anchor sleeve, this reliably achieves the effect that the injection mortar fills the pores of the foam at least in sections. For example, in such a case, a toroidal structure is formed immediately beyond an entry element or cell wall of the opening, the external diameter of the toroidal structure is greater than the internal diameter of the opening, and hence a reliable form fit of the anchor sleeve and the article is achieved. In principle, the injection mortar can therefore be introduced at any point along the length of the interior of the anchor sleeve. A form fit achievable by means of the foam and the injection mortar can thus be matched to the geometry of an article, for example the position of the cell walls in a hollow brick, and the required amount of injection mortar can be reduced.

Further features and advantages of the invention will be apparent from the claims and the description below of a preferred embodiment of the invention in association with the drawings. The drawings show:

### BRIEF DESCRIPTION OF THE DRAWINGS

FIG. 1 an anchor sleeve according to the invention in an oblique view from the top,

FIG. 2 a side view of the anchor sleeve from FIG. 1,

FIG. 3 a view of the section plane III-III in FIG. 2,

FIG. 4 a side view of a carrier of the anchor sleeve from FIG. 1,

FIG. 5 a further side view of the anchor sleeve from FIG. 1, where the anchor sleeve in FIG. 5 is rotated by 90° about the longitudinal centre axis compared to the diagram from FIG. 2,

FIG. 6 a further diagram of the carrier of the anchor sleeve from FIG. 4, where the carrier has been rotated by 90° about the longitudinal centre axis compared to the diagram from FIG. 4,

FIG. 7 a top view of the anchor sleeve from FIG. 1,

FIG. 8 a bottom view of the anchor sleeve from FIG. 1,

FIG. 9 the carrier from FIG. 4 in a disassembled state,

FIG. 10 the carrier from FIG. 9 in a view rotated by 90° compared to the diagram from FIG. 9,

FIG. 11 a tube-like element made of foam prior to insertion into the carrier of the anchor sleeve from FIG. 1,

FIG. 12 a schematic diagram of the outline of the tube-like element from FIG. 11 for illustration of the geometry of the tube-like element,

FIG. 13 a side view of the tube-like element from FIG. 11 and FIG. 12,

FIG. 14 a view of the section plane XIV-XIV in FIG. 13,

FIG. 15 a further side view of the tube-like element from FIG. 13, with rotation of the tube-like element in FIG. 15 by 90° about its longitudinal centre axis compared to the diagram from FIG. 13,

FIG. 16 a view of the section plane XVI-XVI in FIG. 15,

FIG. 17 a top view of the tube-like element from FIGS. 11 and 12,

FIG. 18 a bottom view of the tube-like element from FIGS. 11 and 12,

FIG. 19 a side view of an anchor sleeve inserted into an opening in an article until a bottom end of the annular flange of the entry bushing adjoins a surface of the article and

FIG. 20 a schematic representation depicting injection mortar exiting from the outer circumference of the tube-like element from FIGS. 11 and 12.

### DETAILED DESCRIPTION

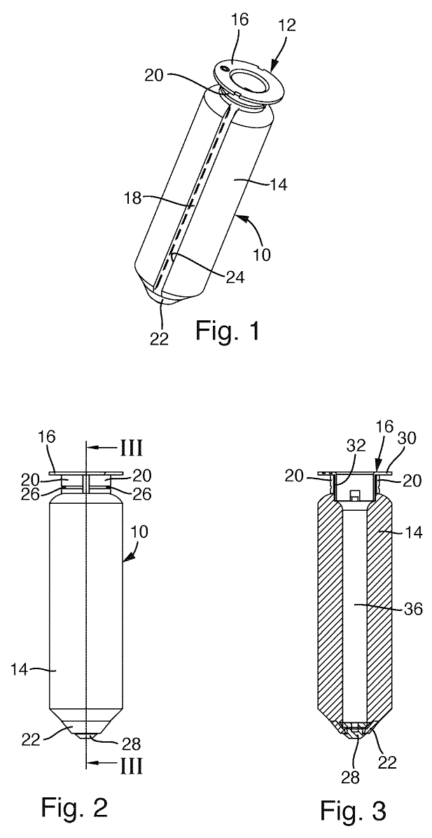

FIG. 1 shows an anchor sleeve 10 according to the invention having a carrier 12 made of plastic. The carrier 12 consists of durable plastic, for example polyurethane or polypropylene, which is mechanically durable and flexible only to a very small degree. In other words, the carrier 12 consists of a plastic as also used, for example, for plastic dowels.

The anchor sleeve 10 additionally has a tube-like element 14 made of a coarse-pore, open-cell or open-pore foam. The foam is, for example, a filter foam based on polypropylene (PP), polyamide (PA), polyethylene (PET) or the like, as also used as filter material in aquarium keeping. It is also possible to use an open-cell or open-pore polyether foam. In all cases, a porosity of the foam is between 15 pores per inch (PPI) and 25 PPI, and is in particular 20 PPI.

The tube-like element 14 is clamped to the carrier 12. In the context of the invention, the tube-like element may also be clamped, welded or force-fittingly or cohesively bonded in some other way to the carrier.

The carrier 12 has an entry bushing 16 that forms a ring-shaped entry flange. The carrier 12 also has two connecting strips 18, only one of which is apparent in FIG. 1. The connecting strip 18 visible in FIG. 1 connects a half-shell 20 to an end piece 22 which is formed in a frustoconical shape on the outer face and on the inner face which is not visible in FIG. 1. The end piece 22, the two connecting strips 18 and also the two half-shells 20 have been produced from a one-piece plastics part. The entry bushing 16 likewise consists of a one-piece plastics part.

The tube-shaped element 14 has, parallel to its longitudinal centre axis, two grooves 24 that extend inward from the outside, although only one of the grooves is apparent in FIG. 1. Each of the grooves 24 accommodates one connecting strip 18.

The half-shells 20 each have a groove or notch 26; see FIG. 2. This notch 26 serves for insertion of a wire that then prestresses the two half-shells 20 against a cylindrical section of the entry bushing 16. A section of the tube-shaped element 14 is clamped between the half-shells 20 and an outer wall of the cylindrical section of the entry bushing 16, which will be elucidated hereinafter. A wire disposed in the notch 26 is pulled taut in order to clamp the tube-shaped element 14 made of foam by inward prestressing of the half-shells 20 against the entry bushing 14. In the context of the invention, a different way of connecting the two half-shells 20 is of course possible, for example by means of a spring washer, a ring-shaped collar on the entry bushing 16 or else by means of bonding or welding.

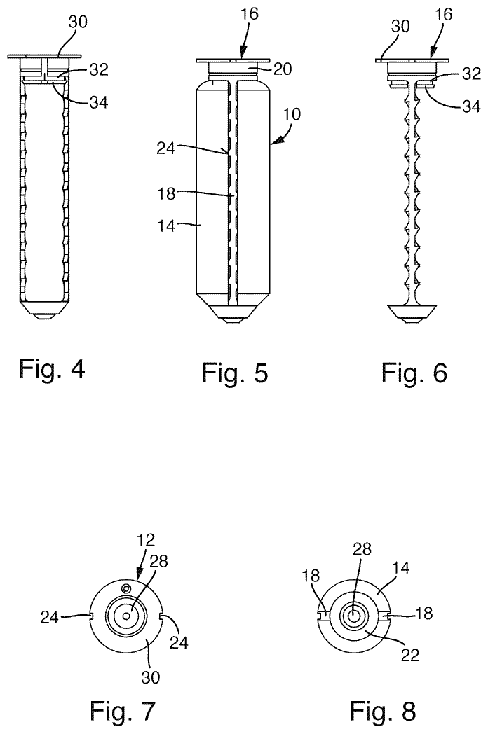

FIG. 2 shows the frustoconical end piece 22 which, as has been stated, is in one-piece form with the two connecting strips 18 and the two half-shells 20, although the two connecting strips 18 are not apparent in the view from FIG. 2, but see FIG. 4.

FIG. 5 shows a side view of the anchor sleeve 10 that has been rotated by 90° compared to the side view from FIG. 2. This view shows one of the connecting strips 18 and one of the half-shells 20. FIG. 5 also shows that the connecting strip 18 has been accommodated in the groove 24 of the tubular element 14 made of foam.

FIG. 2 and FIG. 5 show sections of a clamping rivet 28 which is pushed from the inside through an opening in the end piece 22, where it locks in place and hence also clamps the tubular element 14 made of foam to the end piece 22.

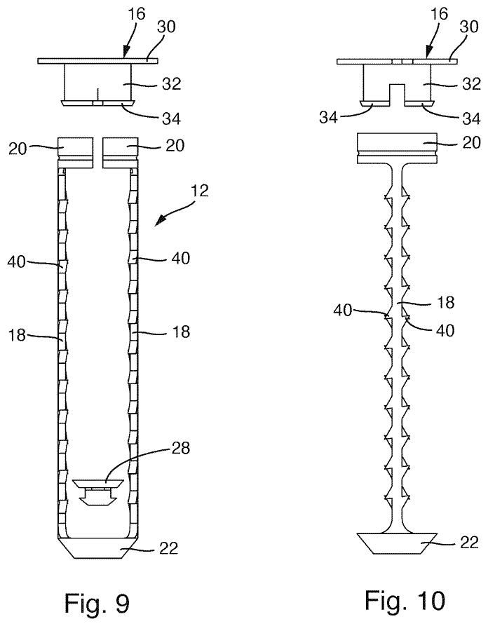

FIG. 3 shows a section view of the section plane III-III in FIG. 2. This section view from FIG. 3 does not show the connecting strips 18 since they are in a perpendicular arrangement to the section plane III-III. FIG. 3 firstly shows the formation of the entry bushing 16 with an annular entry flange 30 and a cylindrical section 32. The cylindrical section 32, cf. FIG. 4 and FIG. 6, has been provided at its lower end with latching lugs 34 that extend outward. This is also readily apparent in FIG. 9 and FIG. 10.

FIG. 3 shows that a section of the tubular element 14 made of foam that adjoins the entry flange 30 is compressed between the two half-shells 20 and clamped against the cylindrical section 32 of the entry bushing 16. The tubular element 14 is thus reliably clamped to the half-shells 20 and the entry bushing 16 since, as has been stated, the half-shells 20 have indeed been prestressed radially inward, for example by means of a circumferential wire that has been pulled taut.

The tubular element 14 has additionally been clamped to the end piece 22 by means of the clamping rivet 28. For this purpose, the clamping rivet 28 is pushed through a blind hole 36 in the tubular element 14 down to the base of the blind hole, then pushed through the base of the blind hole until it locks in place in the opening of the end piece 22, as shown in FIG. 3. Since the tubular element 14 consists of a coarse-pore open-cell foam which is very flexible, the clamping rivet 28 can be pushed through the base of the blind hole in the tubular element 14 and then be locked in place and anchored in the opening in the end piece 22. By means of the clamping rivet 28, the tubular element 14 made of foam is thus also reliably clamped to the end piece 22.

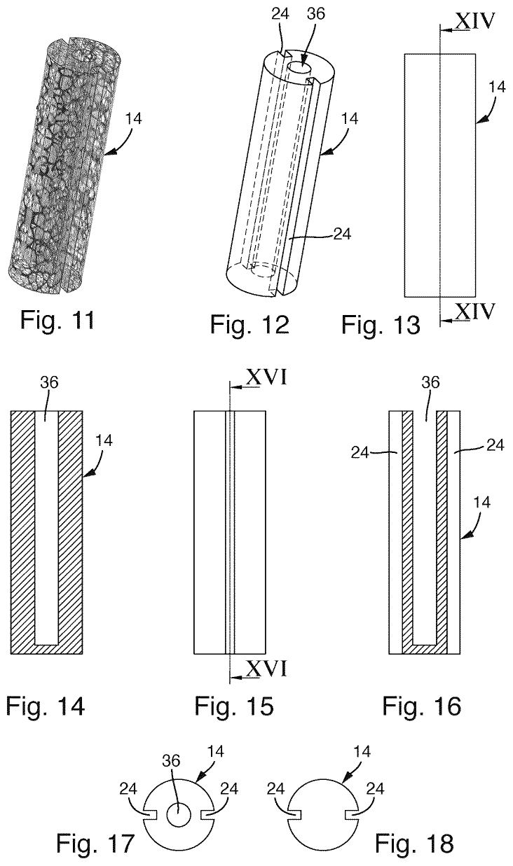

FIGS. 11 to 18 show the tubular element 14 made of foam prior to insertion into the carrier 12. The section views in FIG. 14 and FIG. 16 clearly show the formation of the tubular element 14 with the central blind hole 36. In FIG. 16, the section plane runs through the two grooves 18 that extend inward from the outer surface of the tubular element 14 and which, as has been stated, are each intended for accommodation of one connecting strip 18 of the carrier 12.

FIG. 11 was an attempt to illustrate the coarse-pore open-cell structure of the tubular element 14 made of foam.

FIG. 17 shows a top view of the tubular element 14. The blind hole 36 and the two grooves 24 are apparent. FIG. 18 shows a bottom view of the tubular element 14. The blind hole 36 cannot be seen in this view, only the two grooves 24.

FIG. 7 shows a top view of the anchor sleeve 12 from FIG. 1. This view looks into the blind hole 36, and the clamping rivet 28 is apparent at the base of the blind hole; cf. FIG. 3.

FIG. 8 shows a bottom view of the anchor sleeve 10. The connecting strips 18 start from the end piece 22 and are disposed in the grooves 24 of the tubular element 14. A clamp section of the clamping rivet 28 that has been pushed through the middle opening of the end piece 22 is likewise apparent.

The procedure for assembly of the carrier 12 and the tubular element 14 to form the anchor sleeve 10 may be as follows. This refers to FIGS. 11 to 18, which show the tubular element 14 made of foam prior to assembly together with the carrier 12, and to FIGS. 9 and 10, which show the carrier 12 prior to assembly. FIG. 9 shows the clamping rivet 28; in FIG. 10, the clamping rivet 28 has been omitted for clarity. As has already been stated, the assembled anchor sleeve is shown in FIGS. 1 to 3, and 7 and 8.

For mounting of the tubular element 14 on the carrier 12, the tubular element 14 is first inserted between the two connecting strips 18 until the end of the tubular element 14 with a closed base, see FIG. 18, rests on the inside of the frustoconical end piece 22. For this purpose, the two connecting strips 18 may be bent outward to some degree in order to insert the tubular element 14 between the two connecting strips such that the two connecting strips 18 are disposed in the grooves 24 of the tubular element 14; see, for example, FIG. 1 and FIG. 5. The two half-shells 20 then rest on an outer face of the tubular element 14.

FIG. 9 and FIG. 10 show that two connecting strips 18 have been provided with sawteeth 40. These sawteeth 40 mesh into the foam material of the tubular element 14 and prevent the tubular element 14 from moving parallel to a longitudinal centre axis of the anchor sleeve 10, cf. FIG. 1. The sawteeth 40 of the two connecting strips 18 extend here in circumferential direction of the tubular element 14, such that the sawteeth 40 thus engage into the sidewalls of the grooves 24 in the tubular element 24.

FIG. 10 shows that sawteeth 40 are arranged over virtually the entire length of the connecting strip 18 on both sides of the connecting strips 18. On one side, the left in FIG. 10, the steep flank of the sawteeth 40 faces the end piece 22, and on the opposite side, the right in FIG. 10, the steep flank of the sawteeth faces the half-shell 20. By means of the sawteeth 40, it is thus possible to prevent movement of the tubular element 14 relative to the carrier 12 in the direction of the end piece 22, and also in the opposite direction, i.e. in the direction of the half-shell 20.

After the tubular element 14 has been inserted between the two connecting strips 18, the clamping rivet 28 is introduced into the blind hole 36 in the tubular element 14, cf. also FIG. 3, and then pushed through the base of the blind hole into the centre opening of the end piece 22. The clamping rivet is guided here by means of a suitable rod-shaped tool that engages into a blind-end bore in the clamping rivet 28, which is apparent in FIG. 3. The clamping rivet 28 is moved toward the end piece 22 until latching lugs engage at the lower end of the clamping rivet 28 in FIG. 9 and FIG. 3 via a boundary edge of the middle opening in the end piece 22. The base of the tubular element 14 made of foam is significantly compressed here and simultaneously clamped on the end piece 22.

Subsequently, the entry bushing 16 is inserted or pushed into the blind hole 36 in the tubular element 14 until a top end of the tubular element 14 adjoins a bottom end of the annular flange 30 of the entry bushing 16. The half-shells 20 then likewise adjoin a bottom end of the annular flange 30 or are disposed at a very short distance from the bottom end of the annual flange 30. Subsequently, as has already been discussed, the two half-shells 20 are pushed inward and fixed in this position pushed inward, for example by means of a wire or spring washer surrounding the two half-shells 20. The latching lugs 34 on the entry bushing 16 then lie, see FIG. 4 and FIG. 6, beneath an edge of the half-shells 20 facing the end piece 22. The entry bushing is thus fixed on the half-shells 20, and the tubular element 14 also lies between an outer wall of the cylindrical section 32 of the entry bushing 16 and respective inner walls of the half-shells 20 and is thus reliably clamped to the carrier 12. This results in the shape of the tubular element 14 which is apparent in FIGS. 1, 2, 3 and 5, and which is highly compressed and clamped in the region of the end piece 22 and in the region of the entry bushing 16.

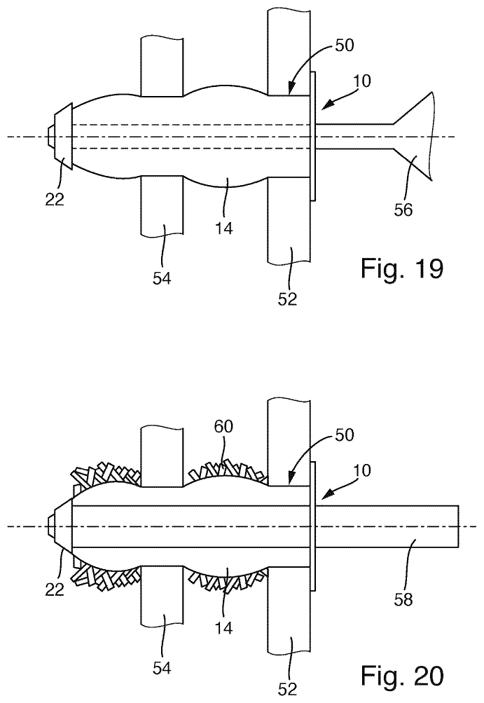

In order to secure an anchor element in an opening of an article by means of the anchor sleeve 10, the anchor sleeve 10, see FIG. 19, is inserted into an opening in an article until a bottom end of the annular flange 30 of the entry bushing 16 adjoins a surface of the article. In the case of FIG. 19, the opening is designed as a borehole in a hollow brick. FIG. 19 shows that an internal diameter of a borehole 50 in the hollow brick is smaller than an external diameter of the tubular element 14 of the anchor sleeve 10. The tubular element 14 is thus compressed in the region of the cell walls 52, 54 of the hollow brick, but outside the cell walls 52, 54 the tubular element 14 attempts to readopt its original shape and is therefore curved outward and therefore has a greater external diameter between or alongside the cell walls 52, 54 than the diameter of the borehole 50 in the cell walls 52, 54. In order to be able to insert the anchor sleeve 10 into the opening 50 at all, an injection mortar injector 56, shown merely schematically and in sections in FIG. 19, is pushed as far as the base of the blind hole in the tubular element 14, i.e. until the free end of the injection mortar injector 56 hits the inside of the end piece 22. The anchor sleeve 10 can thus be pushed or inserted without difficulty into the opening, even when it has extended through several cell walls or a wall of a hole with loosened sites until the position shown in FIG. 19 has been attained.

Proceeding from the situation shown in FIG. 19, introduction of injection mortar into the blind hole in the tubular element 14 is commenced by means of the injection mortar injector 56. This is done in several strokes, typically by means of six strokes, with movement of the injection mortar injector 56 a little further out of the blind hole in the tubular element 14 after each stroke. This is referred to as filling of the anchor sleeve 10 from the base.

Alternatively, after the anchor sleeve 10 has been inserted, proceeding from the situation shown in FIG. 19, the injection mortar injector can be retracted and the injection mortar can be introduced from the start of the blind hole, i.e. at about the level of the cell wall 52.

Even when the blind hole 36 in the tubular element 14 is being filled with injection mortar, the injection mortar penetrates into and at least partly fills the open pores of the tubular element 14 made of foam. It is already apparent in FIG. 19 that so-called plugging results even from simple filling of the foam with the injection mortar. It is sufficient here when only the pores of the tubular element 14 are filled with injection mortar. This is because the tubular element 14 already bulges outward between the cell walls 52, 54 and alongside the cell wall 54, and hence already forms a form fit to the cell walls 52, 54. This form fit, in the cured state of the injection mortar, prevents the anchor sleeve 10 with an anchor element disposed therein from being able to be pulled out of the article or out of the opening 50.

Typically, however, the injection mortar exits from the outer face of the tubular element 14 no later than when an anchor element is inserted into the anchor sleeve 10, and hence improves a form fit and also a cohesive bond to the article, i.e. in the case shown to the cell walls 52, 54 of a hollow brick.

Proceeding from the state in FIG. 19, as described, the anchor sleeve is filled with injection mortar, the injection mortar injector 56 is pulled out of the anchor sleeve 10, and an anchor element, typically an anchor rod 58, see FIG. 20, is pushed into the anchor sleeve 10 even before the injection mortar has cured.

The injection mortar used may be free-radically curing injection mortar or else, for example, an epoxy resin. What is crucial is that the injection mortar is pasty or viscous in the uncured state, such that it can penetrate into the pores of the tubular element 14 made of foam and such that it can be displaced from the blind hole 36 in the tubular element 14 on insertion of the anchor rod 58. FIG. 20 shows a schematic section view of the anchor sleeve 10. It is apparent that the anchor rod 58 has been inserted into the anchor sleeve 10 up to the inside of the end piece 22 of said anchor sleeve. The end piece 22 forms a reliable stop here. It is further apparent that the external diameter of the anchor rod 58 is greater than or equal to the internal diameter of the blind hole 36. It is ensured thereby that the outer circumference of the anchor rod 58 adjoins the inner circumference of the blind hole 36 in the tubular element 14 made of foam. In order to form a cohesive bond and form fit with the injection mortar, it is not necessary that the injection mortar flows back, but is instead pushed automatically into contact with the outer circumference of the anchor rod 58 as a result of the flexibility and elasticity of the foam in the tubular element 14.

FIG. 20 shows, in schematic form, how the injection mortar 60 exits from the outer circumference of the tubular element 14. An attempt has been made to show that the injection mortar exits in unaligned filaments or strands. This is because the pores in the tubular element 14 are not in a regular arrangement. The individual strands of the injection mortar 60 that exit from the tubular element 14 become joined to one another as a result. What is called the spaghetti effect in the case of conventional perforated sleeves, where the strands lie alongside one another in an ordered manner and do not become joined to one another, thus cannot occur in the case of the anchor sleeve 10 according to the invention. Instead, the exiting strands of the injection mortar 60 become wedged and interlaced and hence enhance the form fit of the anchor sleeve 10 to the cell walls 52, 54 of the hollow brick.

The arrangement shown in FIGS. 19 and 20 with an anchor element, i.e. the anchor rod 58 and the anchor sleeve 10 according to the invention and the opening 50 in an article, namely a hollow brick, consequently ensures high anchoring forces and a reliable form fit of the anchor sleeve 10 and of the injection mortar 60, and of the anchor rod 58 in the article, i.e. the hollow brick.

A further form fit between the anchor sleeve 10 and the cell walls 52, 54 does of course also occur in the region of the cell walls 52, 54. Unevennesses in the inner wall of the opening 50 are filled with injection mortar. In addition, in the region of the cell walls 52, 54, a cohesive bond can also be achieved between the material of the cell walls 52, 54 and the injection mortar 60.

1. Anchor sleeve (10) for an injection system for securing an anchor element in an opening (50) in an article, especially in a borehole in masonry, characterized in that the anchor sleeve (10) consists at least in sections of flexible permeable open-cell foam.

2. Anchor sleeve (10) according to claim 1, characterized in that the anchor sleeve (10) has a tubular element (14) made of the foam.

3. Anchor sleeve (10) according to claim 2, characterized in that the tube-like element (14) made of foam forms a blind hole.

4. Anchor sleeve (10) according to any of the preceding claims, characterized in that a number of pores in the foam is between 15 ppi (pores per inch) and 25 ppi, especially 20 ppi.

5. Anchor sleeve (10) according to at least one of the preceding claims, characterized in that a carrier (12) has been provided with an end piece (22) and an entry flange (30), where the foam is secured to the carrier (12).

6. Anchor sleeve (10) according to claim 5, characterized in that the end piece (22) and the entry flange (30) are joined by means of at least one connecting strip (18).

7. Anchor sleeve (10) according to claim 6, characterized in that the at least one connecting strip (18) has been provided with anchoring elements, especially sawteeth (40) and/or hooks, for engaging with the foam.

8. Anchor sleeve (10) according to claim 7, characterized in that the sawteeth (40) and/or hooks extend away from the connecting strip (18) in circumferential direction of the tube-like element (14) made of foam.

9. Anchor sleeve (10) according to claim 7 or 8, characterized in that the sawteeth (40) are aligned partly in a direction toward the end piece (22) and partly in a direction away from the end piece (22).

10. Anchor sleeve (10) according to at least one of claims 6 to 9, characterized in that the tube-like element (14) made of foam has been provided with at least one groove (24) that runs in the longitudinal direction and in that the connecting strip (18) is disposed in the groove (24).

11. Anchor sleeve (10) according to claim 10, characterized in that the groove (24) extends from an outer face of the tube-like element inward.

12. Anchor sleeve (10) according to at least one of the preceding claims, characterized in that a carrier (12) has been provided with an end piece (22) and an entry flange (30), where the foam is connected to the end piece (22) and/or to the entry flange (30), especially clamped to the end piece (22) and to the entry flange (30).

13. Anchor sleeve according to claim 12, characterized in that the end piece (22) has been provided with a passage opening and in that the foam is clamped to the end piece (22) by means of a clamping rivet (28) inserted into the passage opening.

14. Anchor sleeve according to claim 12 or 13, characterized in that the at least one connecting strip, at its opposite end from the end piece (22), has been provided with a holding shell, and in that the entry flange (30) is formed by means of an entry bushing (16), where the foam is clamped between the holding shell (20) and the entry bushing (16).

15. Anchor sleeve according to claim 12, 13 or 14, characterized in that the end piece (22), on its side facing the entry flange (30), has been provided with a frustoconical guide section that tapers in the direction away from the entry flange (30).

16. Arrangement having an anchor element and an anchor sleeve (10) according to at least one of the preceding claims, characterized in that the anchor sleeve (10) has a tube-like element made of the foam and in that the anchor element has an anchoring section designed for insertion into the tube-like element (14), where an internal diameter of the tube-like element (14), at least in sections, is smaller than or equal to the external diameter of the anchor element in the anchoring section.

17. Arrangement according to claim 16, characterized in that an external diameter of the tube-like element (14), at least in sections, is greater than the internal diameter of an opening (50) intended for introduction of the anchor sleeve (10).

18. Arrangement according to claim 16 or 17, characterized in that the anchor element has been inserted into the anchor sleeve (10) to such an extent that one end of the anchor element adjoins an inner face of an end piece (22) of the anchor sleeve (10).

19. Arrangement having an anchor sleeve according to at least one of claims 1 to 15, wherein the anchor sleeve (10) has a tube-like element (14) made of foam, having an anchor element, having an opening (50) in an article, especially a borehole in a building wall, and having injection mortar, characterized in that the anchor sleeve (10) has been inserted at least in sections into the opening (50), in that the injection mortar has at least partly filled the pores in the foam, in that the anchor element has been inserted in sections into the anchor sleeve (10), in that the foam has been displaced radially outward at least in sections with respect to a starting position prior to the introduction of injection mortar into the anchor sleeve (10) and prior to insertion of the anchor element into the anchor sleeve (10), and in that the anchor element at least in sections adjoins an inner face of the tube-like element (14), the pores of which have been at least partly filled with the injection mortar.

20. Arrangement according to claim 19, characterized in that a section of the tube-like element (14) made of foam, the pores of which have been at least partly filled with the injection mortar, immediately beyond an entry element (52) of the opening (50), forms a toroidal structure, the external diameter of which is greater than the internal diameter of the opening (50).

21. Arrangement according to claim 19, characterized in that a section of the tube-like element (14) made of foam, the pores of which have been at least partly filled with the injection mortar, between the opening (50) and a further opening in an inner element (54) of the article, forms a cylindrical or toroidal structure, the external diameter of which is greater than the internal diameter of the opening (50).

22. Method of securing an anchor element in an opening (50) of an article by means of an anchor sleeve according to at least one of claims 1 to 15, characterized by insertion of at least sections of the anchor sleeve (10) into the opening (50), introduction of injection mortar into the anchor sleeve (10) and insertion of sections of the anchor element into the anchor sleeve (10).

23. Method according to claim 22, characterized by placing of the anchor sleeve (10) onto an injection mortar injector (56), especially until a free end of the injection mortar injector (56) hits an end piece (22) of the anchor sleeve (10), and inserting the anchor sleeve (10) into the opening together with the injection mortar injector.

24. Method according to claim 22 or 23, characterized by insertion of the injection mortar into the anchor sleeve (10) beginning from the base of the anchor sleeve (10).

25. Method according to claim 22 or 23, characterized by insertion of the injection mortar into the anchor sleeve (10) beginning at the open end or just beyond the open end of the anchor sleeve (10), especially beginning in a first third of the length of the anchor sleeve (10).
